(19) United States
(12) Patent Application Publication
(10) Pub. No.: US 2023/0246158 A1
(43) Pub. Date: Aug. 3, 2023

(54) CYCLE LIFE IN SI/LI BATTERIES USING HIGH TEMPERATURE DEEP DISCHARGE CYCLING

(71) Applicant: Enevate Corporation, Irvine, CA (US)

(72) Inventors: Samuel Keene, Long Beach, CA (US); Vincent Giordani, Irvine, CA (US); Jeremy Chang, Irvine, CA (US); Benjamin Yong Park, Mission Viejo, CA (US); Frederic Bonhomme, Aliso Viejo, CA (US); Hong Zhao, Irvine, CA (US)

(21) Appl. No.: 17/591,246

(22) Filed: Feb. 2, 2022

(51) Int. Cl. H01M 4/04; H01M 10/44; H01M 4/134; H01M 10/0525

(52) U.S. Cl. CPC H01M 4/0447; H01M 10/446; H01M 4/134; H01M 10/0525; H01M 2010/4271

(57) ABSTRACT

Systems and methods are provided for improvement of cycle life in Si/Li batteries using high temperature deep discharge cycling. One or more deep discharge cycles may be applied to a cell that includes a cathode, a separator, and a silicon-dominant anode, with each of the one or more deep discharge cycles including at least charging and discharging the cell, and with each of the one or more deep discharge cycles being performed at a higher temperature that is above normal operating temperature range. The higher temperature may be 40° C. or higher, 45° C. or higher, or around 45° C.

### CROSS-REFERENCE TO RELATED APPLICATIONS

This patent application is related to U.S. patent application Ser. No. 17/231,788 filed on Apr. 15, 2021. The above identified application is hereby incorporated herein by reference in its entirety.

### TECHNICAL FIELD

Aspects of the present disclosure relate to energy generation and storage. More specifically, certain implementations of the present disclosure relate to methods and systems for Improvement of cycle life in Si/Li batteries using high temperature deep discharge cycling.

### BACKGROUND

Various issues may exist with conventional battery technologies. In this regard, conventional systems and methods, if any existed, for designing and producing batteries or components thereof may be costly, cumbersome, and/or inefficient—e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for Improvement of cycle life in Si/Li batteries using high temperature deep discharge cycling, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1A illustrates an example battery.

FIG. 1B illustrates an example battery management system (BMS) for use in managing operation of batteries.

FIG. 2 is a flow diagram of an example lamination process for forming a silicon anode.

FIG. 3 is a flow diagram of an example direct coating process for forming a silicon anode.

FIG. 4 is a graph diagram illustrating comparisons in discharge capacity characteristics when operating cells of similar design, under similar cycling conditions, with and without use of high temperature deep discharge cycles in accordance with the present disclosure.

FIG. 5 is a graph diagram illustrating comparison in cycling performance of batteries between standard formation protocol and an improved formation protocol in accordance with the present disclosure.

### DETAILED DESCRIPTION

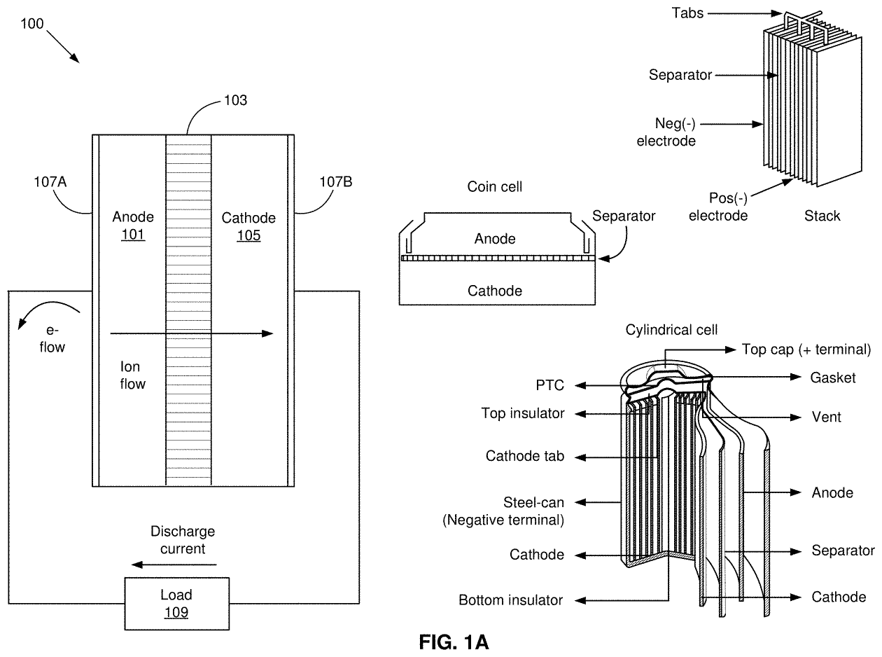

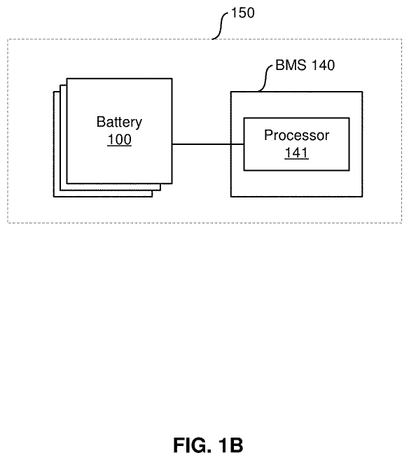

FIG. 1A illustrates an example battery. Referring to FIG. 1A, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack. Furthermore, the battery 100 shown in FIG. 1A is a very simplified example merely to show the principle of operation of a lithium ion cell. Examples of realistic structures are shown to the right in FIG. 1A, where stacks of electrodes and separators are utilized, with electrode coatings typically on both sides of the current collectors. The stacks may be formed into different shapes, such as a coin cell, cylindrical cell, or prismatic cell, for example.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode 105 are electrically coupled to the current collectors 107A and 107B, which comprise metal or other conductive material for providing electrical contact to the electrodes as well as physical support for the active material in forming electrodes.

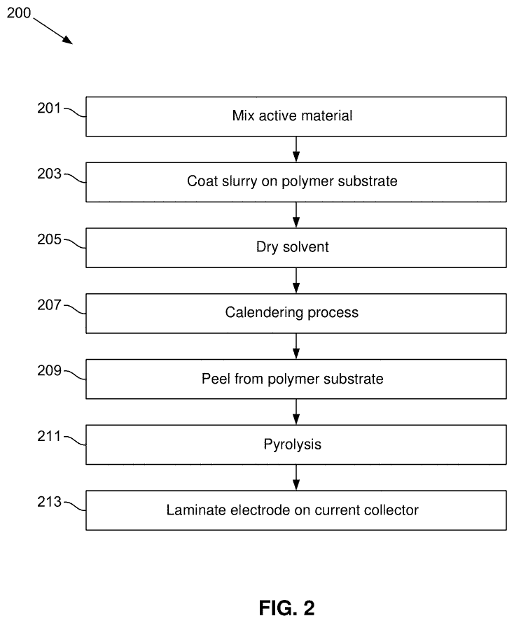

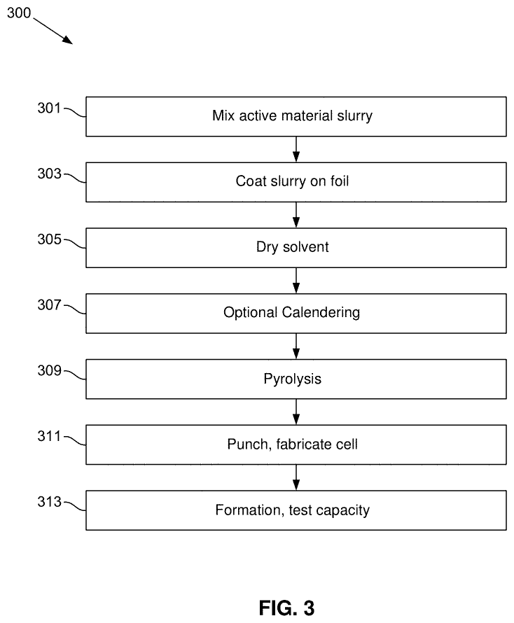

The configuration shown in FIG. 1A illustrates the battery 100 in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. In this regard, different methods or processes may be used in forming electrodes, particularly silicon-dominant anodes. For example, lamination or direct coating may be used in forming a silicon anode. Examples of such processes are illustrated in and described with respect to FIGS. 2 and 3. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc. In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.1 to 2.0 molar (M) and lithium bis(trifluoromethanesulfonyl)imide (LiTFSI) may be present at a concentration of about 0 to 2.0 molar (M). Solvents may comprise one or more of ethylene carbonate (EC), fluoroethylene carbonate (FEC) and/or ethyl methyl carbonate (EMC) in various percentages. In some embodiments, the electrolyte solvents may comprise one or more of EC from about 0-40%, FEC from about 2-40% and/or EMC from about 50-70% by weight.

The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Silicon anodes may be formed from silicon composites, with more than 50% silicon or more by weight in the anode material on the current collector, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1A for example, and vice versa through the separator 103 in charge mode. The movement of the lithium ions creates free electrons in the anode 101 which creates a charge at the positive current collector 1078. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (Super P), vapor grown carbon fibers (VGCF), and a mixture of the two have previously been incorporated separately into the anode electrode resulting in improved performance of the anode. The synergistic interactions between the two carbon materials may facilitate electrical contact throughout the large volume changes of the silicon anode during charge and discharge as well as provide additional mechanical robustness to the electrode and provide mechanical strength (e.g., to keep the electrode material in place). Graphenes and carbon nanotubes may be used because they may show similar benefits. Thus, in some instances, a mixture of two or more of carbon black, vapor grown carbon fibers, graphene, and carbon nanotubes may be used as such mixtures or combinations may be especially beneficial.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (3579 mAh/g vs. 372 mAh/g for graphite) and volumetric capacities (2194 mAh/L vs. 890 mAh/L for graphite). In addition, silicon-based anodes have a low lithiation/delithiation voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life.

In some embodiments, dedicated systems and/or software may be used to control and manage batteries or packs thereof. In this regard, such dedicated systems may comprise suitable circuitry for running and/or executing control and manage related functions or operations. Further, such software may run on suitable circuitry, such as on processing circuitry (e.g., general processing units) already present in the systems or it may be implemented on dedicated hardware. For example, battery packs (e.g., those used in electric vehicles) may be equipped with a battery management system (BMS) for managing the batteries (or packs) and operations. An example battery management system (BMS) is illustrated in and described in more detail with respect to FIG. 1B.

In accordance with the present disclosure, control and management of batteries, particularly lithium-ion (“Li-ion”) batteries with silicon-dominant anodes (also referred to herein as “Si/Li batteries” or “Si—Li batteries”), and operation thereof may be improved. In particular, cycle life in Si/Li batteries may be improved using high temperature deep discharge cycling. In particular, high temperature deep discharge cycling may be preferably, but not exclusively, used during battery formation. In this regard, battery formation typically refers to the initial cycling of a battery, which may be performed in a controlled environment and with predefined conditions, and which is usually performed before use (e.g., in the factory). Battery formation may be used for various purposes, which may differ between conventional Li-ion batteries (e.g., Li-ion with batteries graphite-dominant anodes) and Li/Si batteries (Li-ion batteries with silicon-dominant anodes). In particular, whereas battery formation may be used for forming stable solid-electrolyte interface (SEI), battery formation may also be utilized in the case of Li/Si batteries to initiate an irreversible phase transition from crystalline to amorphous Si.

In this regard, in a conventional Li-ion battery, which may comprise a transition metal oxide cathode and a graphite-dominant anode, lithium that is reduced at the electrode surfaces during charge and discharge is intercalated into the crystal lattice of the electrode materials. This process is reversible. However, when the battery is charged for the first time, there is irreversible chemistry that occurs on the electrode surfaces because the surfaces are not yet passivated. Electrolyte in the battery typically oxidizes on the cathode and reduces on the anode to form a solid-electrolyte interface layer (SEI). The mechanical and electrochemical stability of the SEI layer affects the lifetime and temperature stability of the battery. Because of this, the first charge/discharge cycle of a battery—that is, the formation cycle—may be optimized for an individual battery design, to ensure an SEI with optimal properties is formed. In existing solutions, the formation cycle is intended solely to establish stable SEI. Considerations such as optimizing the duration of the formation cycle in order to minimize cost may also exist, but these do not pertain to the physical phenomena the formation cycle is intended to achieve.

In a Li/Si battery, where the anode consists primarily (e.g., more than 50% of the anode capacity) of Silicon, SEI is still established on the electrode surfaces during the formation cycle. However, several other important phenomena occur on the Si anode during formation. For example, during the charge portion of the formation cycle, the crystalline Si particles are irreversibly converted to numerous phases of amorphous Lithium Silicide, and the volume of the anode increases substantially. On the subsequent formation discharge, Li is removed from the anode, causing a decrease in volume. During this discharge the Si particles undergo mechanical rearrangement, generally in the form of particle cracking and pulverization. When this occurs, Li may become trapped in (or become hard to remove from) portions of the cracked particles that have become electronically and/or ionically disconnected from the rest of the anode, resulting in a decrease in overall capacity of the battery.

Some issues, challenges, and/or shortcomings may exist with conventional battery formation solutions, however. For example, existing formation protocols are not typically performed with, and thus are not configured for addressing issues that may be unique to Si/Li batteries, such as re-activating trapped (or hard to remove) Li as may exist in Si/Li batteries. In this regard, existing formation protocols typically are only optimized for SEI stability and thus may not address the issue of trapped (or hard to remove) Li in the Si particles. U.S. patent application Ser. No. 17/231,788, filed on Apr. 15, 2021, which is incorporated herein in its entirety, provides additional description relating to formation processes and use of formation protocols.

Solutions in accordance with the present disclosure may address such issues, such as by facilitating deep discharge that allows for re-activating trapped Li. In this regard, deep discharge achieved using solutions based on the present disclosure is not necessarily limited to re-activating “trapped” Li in Si. Rather, in various implementations deep discharge in accordance with the present disclosure may effectively allow for removing lithium that is harder to remove and putting it back into the cathode before a substantial SEI layer may be grown on the anode and/or increase resistance in the cell. If the resistance grows or SEI is grown with the lithium within the anode, the lithium becomes harder to remove and thus “trapped”. Thus, deep discharge in accordance with the present disclosure may prevent the trapping of lithium.

In various implementations, improved formation protocols are used, providing improved performance, particularly with respect to life cycle of the batteries, compared to standard formation protocols. In this regard, a formation protocol may comprise one or more cycles or partial cycles. Each cycle may be the same or different than other cycles. Each cycle may comprise charging to the maximum operation voltage, or a voltage higher than the maximum operation voltage, or a voltage lower than the maximum operation voltage. Each cycle may comprise discharge to the minimum operation voltage, or a voltage higher than the minimum operation voltage, or a voltage lower than the minimum operation voltage. The charge and discharge steps may be constant current (CC), constant current-constant voltage (CCCV), multi-step constant current, or multi-step constant current-constant voltage based steps. The voltage limits may vary for each cycle, or within one cycle. The rate of charge and discharge may vary for each cycle, or within one cycle. The constant voltage step cutoff may vary for each cycle, or within one cycle. The formation protocol may be based on capacity limits instead of voltage limits, or a combination of capacity limits and voltage limits. The formation protocol may be performed at room temperature, or elevated temperature, or reduce temperature, or a combination of different temperatures at different steps. An improved formation protocol may comprise a step that is performed at elevated temperature (e.g., at 45° C.). The additional step may further comprise discharging to voltage that is considered out of the nominal voltage range of the cell—that is, discharging to a minimum discharge voltage that is below the normal operating minimum discharge voltage of the battery. This step may be imbedded into a standard formation protocol—e.g., being performed in addition to other steps of the standard formation protocol.

Accordingly, in an example embodiment, an improved formation protocol for a battery containing anodes with silicon as >50% of the active material that is performed at a temperature higher than the operating temperature of the battery, which enhances the cycle life of the battery. The formation comprises initial charging and discharging of the battery, which is performed with a specific protocol, and which may be considered a part of the manufacturing process of the battery.

In an example embodiment, an improved formation protocol for a battery that is performed with a minimum discharge voltage below the operating minimum discharge voltage of the battery, which enhances the cycle life of the battery.

In an example embodiment, the formation protocol may be configured to improve coulombic efficiency and/or irreversible capacity compared to a standard formation cycle.

In an example embodiment, the formation protocol may be configured to improve the nominal energy density of the battery.

In an example embodiment, the formation protocol may be configured to specifically improve the performance of a Li/Si battery.

In an example embodiment, the formation protocol may be configured where the temperature and voltage ranges are set so that >87%, >88%, >89% and >90% of the capacity is discharged during formation compared to what is charged for cells containing NMC cathode where the N:NMC ratio is higher than 0.5 (e.g., 50% or more nickel) and also containing anodes with silicon as >50% of the active material.

In an example embodiment, the formation protocol may be configured where the temperature and voltage ranges are set so that >81%, >82%, >83% and >84% of the capacity is discharged during formation vs what is charged for cells containing NCA cathode and also containing anodes with silicon as >50% of the active material.

In an example embodiment, the formation protocol may be configured where the temperature and voltage ranges are set so that >81%, >82%, >83% and >84% of the capacity is discharged during formation vs what is charged for cells containing a cathode with more than 50% nickel and also containing anodes with silicon as >50% of the active material.

In an example embodiment, a higher temperature may be used (>40° C., >45° C., or around 45° C.).

In an example embodiment, a low discharge voltage may be used to pull out as much lithium as possible (<2.5V, <2V, <1.5V).

In an example embodiment, a low discharge rate may be used for all or part of the discharge to pull out as much lithium from the anode as possible (<0.1 C, <0.05 C, <0.02 C).

In an example embodiment, a constant voltage hold may be used during all or part of the discharge to pull out as much lithium from the anode as possible (where the voltage hold is at around 2.5V, around 2.0V or around 1.5V).

In an example embodiment, the constant voltage hold may use a cutoff current at around 0.1 C, 0.05 C or around 0.02 C.

An example cycling protocol that incorporates high temperature deep discharge formation may comprise, performing an initial formation cycle (cycle 1) at 45° C., with cycle 1 including rest for 1 minute, charge at 0.1 C to 4.2V until 0.02 C, rest for 5 minutes, discharge at 0.1 C to 1V until 0.02 C, then rest for 5 minutes. The next number of cycles in the cell's life cycle (e.g., cycles 2-100) are performed at lower temperature (e.g., at 25° C.). For example, at each of these cycles may include rest for 1 minute, charge at 4 C to 4.2V until 0.05 C, rest for 5 minutes, discharge at 0.5 C to 3.2V, then rest for 5 minutes. In some instances, a special cycle may be used, to optimize performance. For example, cycle 101, which is also performed at lower temperature (e.g., at 25° C.), may include rest for 1 minute, charge at 0.33 C to 4.2V until 0.05 C, rest for 5 minutes, discharge at 0.33 C to 3.2V, then rest for 5 minutes. The remaining cycles of the life cycle may be performed in similar manner—e.g., cycles 102-200 and 201 being the same as, respectively, cycles 2-100 and 101.

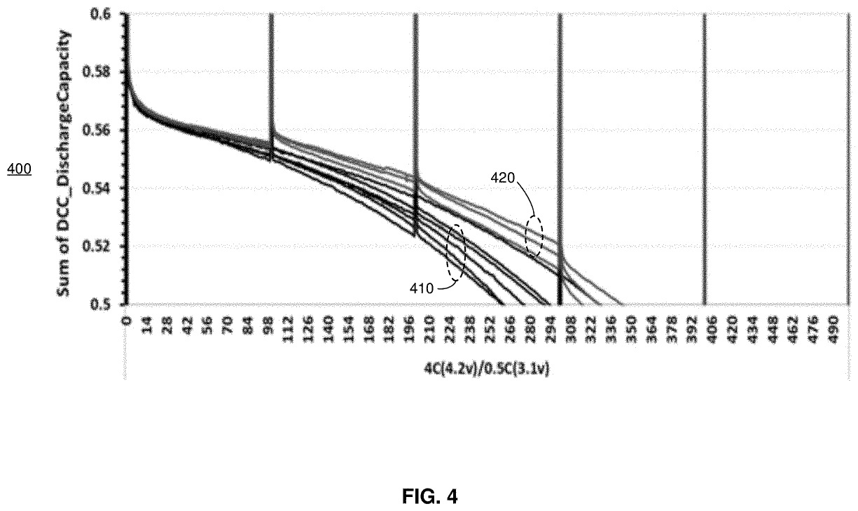

Nonetheless, as noted above, use of high temperature deep discharge cycling is not limited to formation. In this regard, while various embodiments are described in terms of use of high temperature deep discharge formation protocol—that is, with the high temperature deep discharge cycle(s) applied during the formation process—the disclosure is not so limited, and as such, in some example embodiments, high temperature deep discharge cycle(s) may also be applied during the cell's life cycle, such as in addition to and/or in lieu of applying such cycles at formation. For example, one or more high temperature deep discharge cycles may applied (e.g., at set intervals) during the first few cycles (e.g., 200 cycles or so) of the cell's life cycle, with or without applying such the high temperature deep discharge cycle during formation process. This is described in more detail with respect to FIG. 4.

Thus, in addition to applying high temperature deep discharge cycle(s) during formation, similar high temperature deep discharge cycle(s) may be applied after formation. Alternatively, rather than applying high temperature deep discharge cycle(s) during formation, such high temperature deep discharge cycle(s) may be applied after formation. In other words, the high temperature deep discharge cycle(s) may only be applied after formation. Such post-formation high temperature deep discharge cycle(s) may be applied within a pre-defined number of cycles (e.g., within the first 100, 200, or 300 cycles) of the cell's life cycle. Further, where multiple high temperature deep discharge cycles are used (whether including or excluding during formation), such cycles may be applied at pre-defined, regular intervals (e.g., every 50 or 100 cycles), or at different points/intervals within the portion of cell's life cycle where these high temperature deep discharge cycles may be applied.

FIG. 1B illustrates an example battery management system (BMS) for use in managing operation of batteries. Shown in FIG. 1B is battery management system (BMS) 140.

The battery management system (BMS) 140 may comprise suitable circuitry (e.g., processor 141) configured to manage one or more batteries (e.g., each being an instance of the battery 100 as described with respect with FIG. 1A). In this regard, the BMS 140 may be in communication and/or coupled with each battery 100.

In some embodiments, the battery 100 and the BMS 140 may be in communication and/or coupled with each other, for example, via electronics or wireless communication. In some embodiments, the BMS 140 may be incorporated into the battery 100. Alternatively, in some embodiments, the BMS 140 and the battery 100 may be combined into a common package 150. Further, in some embodiments, the BMS 140 and the battery 100 may be separate devices/components, and may only be in communication with one another when present in the same system. The disclosure is not limited to any particular arrangement, however.

In some example implementations, battery control and management systems (e.g., the BMS 140) may be used to implement, and/or may be configured to manage and control use of high temperature deep discharge cycling, as well as high temperature deep discharge formation protocols based thereon, in batteries (particularly Si/Li batteries) as described herein.

FIG. 2 is a flow diagram of an example lamination process for forming a silicon anode. Shown in FIG. 2 is flow chart 200, comprising a plurality of example steps (represented as blocks 201-213) for an example lamination process. In this regard, this process employs a high-temperature pyrolysis process on a substrate, layer removal, and a lamination process to adhere the active material layer to a current collector.

The raw electrode active material is mixed in step 201. In the mixing process, the active material may be mixed, e.g., a binder/resin (such as PI, PAI), solvent (e.g., as organic or aqueous), and conductive additives. The materials may comprise carbon nanotubes/fibers, graphene sheets, graphene oxide, metal polymers, metals, semiconductors, and/or metal oxides, for example. The additives may comprise 1D filaments with one dimension at least 4×, at least 10×, or at least 20× that of the other two dimensions, 2D sheets or mesh with two dimensions at least 4×, at least 10×, or at least 20× that of the other dimension, or 3D structures with one dimension at least 20×, at least 10×, or at least 4× that of the other two, where none of the dimensions are of nanoscale size. Silicon powder with a 1-30 or 5-30 μm particle size, for example, may then be dispersed in polyamic acid resin (15% solids in N-Methyl pyrrolidone (NMP)) at, e.g., 1000 rpm for, e.g., 10 minutes, and then the conjugated carbon/NMP slurry may be added and dispersed at, e.g., 2000 rpm for, e.g., 10 minutes to achieve a slurry viscosity within 2000-4000 cP and a total solid content of about 30%.

In step 203, the slurry may be coated on a substrate. In this step, the slurry may be coated onto a Polyester, polyethylene terephthalate (PET), or Mylar film at a loading of, e.g., 2-4 mg/cm² and then in step 205 undergo drying to an anode coupon with high Si content and less than 15% residual solvent content. This may be followed by an optional calendering process in step 207, where a series of hard pressure rollers may be used to finish the film/substrate into a smoothed and denser sheet of material.

In step 209, the green film may then be removed from the PET, where the active material may be peeled off the polymer substrate, the peeling process being optional for a polypropylene (PP) substrate, since PP can leave ˜2% char residue upon pyrolysis. The peeling may be followed by a pyrolysis step 211 where the material may be heated to >900° C. but less than 1250° C. for 1-3 hours, cut into sheets, and vacuum dried using a two-stage process (120° C. for 15 h, 220° C. for 5 h). The dry film may be thermally treated at, e.g., 1100-1200° C. to convert the polymer matrix into carbon.

In step 213 the electrode material may be laminated on a current collector. For example, a 5-20 μm thick copper foil may be coated with polyamide-imide with a nominal loading of, e.g., 0.2-0.6 mg/cm² (applied as a 6 weight (wt.) % varnish in NMP and dried for, e.g., 12-18 hours at, e.g., 110° C. under vacuum). The anode coupon may then be laminated on this adhesive-coated current collector. In an example scenario, the silicon-carbon composite film is laminated to the coated copper using a heated hydraulic press. An example lamination press process comprises 30-70 seconds at 300° C. and 3000-5000 psi, thereby forming the finished silicon-composite electrode.

The process described above is one example process that represents a composite with fabrication steps including pyrolysis and lamination. Another example scenario comprises a direct coating process in which an anode slurry is directly coated on a copper foil using a binder such as CMC, SBR, Sodium Alginate, PAI, PI, PAA, and mixtures and combinations thereof. The process in this example comprises: direct coat active material on a current collector, dry, calendering, heat treatment.

In a direct coating process, an anode slurry is coated on a current collector with residual solvent followed by a calendaring process for densification followed by pyrolysis (˜500-800° C.) such that carbon precursors are partially or completely converted into pyrolytic carbon. Pyrolysis can be done either in roll form or after punching. If done in roll form, the punching is done after the pyrolysis process.

In another example of a direct coating process, an anode slurry may be coated on a current collector with low residual solvent followed by a calendaring process for densification followed by removal of residual solvent.

In an example scenario, the conductive structural additives, which may be added in step 201 in FIG. 2 or step 301 in FIG. 3, may comprise between 1 and 40% by weight of the anode composition, with between 50% and 99% silicon by weight. The fibrous (1D) particles may have an aspect ratio of at least 4, but may be higher than 10, higher than 20, or higher than 40, for example, and may comprise a tubular or fiber-like conductive structure with nanoscale size in two-dimensions, where carbon-based examples comprise carbon nanotubes, carbon nanofibers (CNF), and vapor grown carbon fibers (VGCP). Other fibrous structures are possible, such as metals, metal polymers, metal oxides

The 2D carbon structures may have an average dimension in the micron scale in each of the two non-nanoscale dimensions that is at least 4× that in the thickness direction, for example, and may be at least 20× larger, or at least 40× larger in the lateral directions as compared to the thickness direction. Graphene sheets are an example of conductive carbon additives, while other 2D structures are possible, such as “wire” meshes of metal or metal polymers, for example.

Furthermore, the active material may comprise 3D conductive structural additives, where the material is not limited to nanoscale in any one dimension. In a 3D additive example, one dimension of the structure may be at least 4×, at least 10×, or at least 20× that of the other two dimensions, where none of the dimensions are of nanoscale size. Examples of 3D conductive structural additives may be “chunks” of carbon, metal, metal polymer, or semiconductors.

In another example scenario, the anode active material layer fabricated with the carbon additive described above may comprise 20 to 95% silicon and in yet another example scenario may comprise 50 to 95% silicon by weight.

FIG. 3 is a flow diagram of an example direct coating process for forming a silicon anode. Shown in FIG. 3 is flow chart 300, comprising a plurality of example steps (represented as blocks 301-313) for an example direct coating process. In this regard, this process comprises physically mixing the active material, conductive additive, and binder together, and coating it directly on a current collector. This example process comprises a direct coating process in which an anode or cathode slurry is directly coated on a copper foil using a binder such as CMC, SBR, Sodium Alginate, PAI, PI, PAA, and mixtures and combinations thereof.

In step 301, the active material may be mixed, e.g., a binder/resin (such as PI, PAI), solvent, and conductive and structural additive. For example, the additives may comprise conductive materials that also provide structural continuity between cracks in the anode following multiple cycles. The materials may comprise carbon nanotubes/fibers, graphene sheets, metal polymers, metals, semiconductors, and/or metal oxides, metal/carbon nanofiber or metal/carbon nanotube composites, carbon nanowire bundles, for example. Silicon powder with a 5-30 μm particle size, for example, may then be dispersed in polyamic acid resin (15% solids in N-Methyl pyrrolidone (NMP)) at, e.g., 1000 rpm for, e.g., 10 minutes, and then the conjugated carbon/NMP slurry may be added and dispersed at, e.g., 2000 rpm for, e.g., 10 minutes to achieve a slurry viscosity within 2000-4000 cP and a total solid content of about 30%.

Furthermore, cathode active materials may be mixed in step 301, where the active material may comprise lithium cobalt oxide (LCO), lithium manganese oxide (LMO), lithium iron phosphate (LFP), lithium nickel cobalt manganese oxide (NMC), lithium nickel cobalt aluminum oxide (NCA), nickel, cobalt, manganese and aluminum (NCMA), lithium nickel manganese spinel, or similar materials or combinations thereof, mixed with a binder as described above for the anode active material.

In step 303, the slurry may be coated on a copper foil. Similarly, cathode active materials may be coated on a foil material, such as aluminum, for example. The active material layer may undergo a drying in step 305 resulting in reduced residual solvent content. An optional calendering process may be utilized in step 307 where a series of hard pressure rollers may be used to finish the film/substrate into a smoother and denser sheet of material. In step 307, the foil and coating proceeds through a roll press for lamination.

In step 309, the active material may be pyrolyzed by heating to 500-1000° C. such that carbon precursors are partially or completely converted into glassy carbon. The pyrolysis step may result in an anode active material having silicon content greater than or equal to 50% by weight, where the anode has been subjected to heating at or above 400° C.

Pyrolysis can be done either in roll form or after punching in step 311. If done in roll form, the punching is done after the pyrolysis process. In instances where the current collector foil is not pre-punched/pre-perforated, the formed electrode may be perforated with a punching roller, for example. The punched electrodes may then be sandwiched with a separator and electrolyte to form a cell. In some instances, separator with significant adhesive properties, in accordance with the present disclosure, maybe utilized.

In step 313, the cell may be subjected to a formation process, comprising initial charge and discharge steps to lithiate the anode, with some residual lithium remaining, and the cell capacity may be assessed.

FIG. 4 is a graph diagram illustrating comparisons in discharge capacity characteristics when operating cells of similar design, under similar cycling conditions, with and without use of high temperature deep discharge cycles in accordance with the present disclosure. Shown in FIG. 4 is graph 400.

The graph 400 illustrates results of example operation runs of example Si/Li cell (battery) cells, with the graph 400 specifically capturing discharge capacity of the cells as a function of number of cycles for each run. In this regard, the data captured in graph 400 correspond to use of a cell that comprises an anode that comprises silicon-conductive carbon-pyrolyzed resin at 86-4-10 wt %, a cathode that comprises NCA-conductive carbon-binder at 92-4-4 wt %, and an electrolyte that comprises 1.2M LiPF₆ in FEC-EMC at 30-70 wt %, and with the cell having 5-layer pouch cell design.

As illustrated in FIG. 4, graph 400 includes line graphs 410 and 420, comprising results corresponding to operating the cells under the same cycling conditions—namely, cycles of charging to 4.2V at 4 C and discharging to 3.1V at 0.5 C (i.e., 4 C (4.2V)/0.5 C (3.1V) cycles)—but with standard regime (line graphs 410) or modified regime, which includes use of high temperature deep discharge cycles (line graphs 420). In particular, as shown in FIG. 4, line graphs 410 represent operation of standard reference cells, specifically with constant current-constant voltage (CCCV) 4 C (0.05 C) charge/CC 0.5 C discharge, with 4.2V-3.1V voltage window, at 25° C. with one intermittent standard reference performance test (RPT) based cycle (e.g., every 100 cycles). The RPT cycle may have the following conditions: constant current-constant voltage (CCCV) 0.33 C (0.05 C) charge/CC 0.33 C discharge, with 4.2V-3.0V voltage window, at 25° C.

Line graphs 420 correspond to operation runs using improved formation, with constant current-constant voltage (CCCV) 4 C (0.05 C) charge/CC 0.5 C discharge, with 4.2V-3.1V voltage window, at 25° C. with one intermittent high temperature deep discharge cycle (e.g., every 100 cycles). The high temperature deep discharge cycle may have the following conditions: constant current-constant voltage (CCCV) 0.1 C (0.02 C) charge/constant current-constant voltage (CCCV) 0.1 C (0.02 C) discharge, with 4.2V-1.0V voltage window, at 45° C.

As data in graph 400 illustrated, use of high temperature deep discharge cycles improves performance, at least partially—as performance is clearly improved at least after the first two high temperature deep discharge cycles (at 100 cycles, and at 200 cycles)—since the same cell design and cycling conditions are used for both sets of tests.

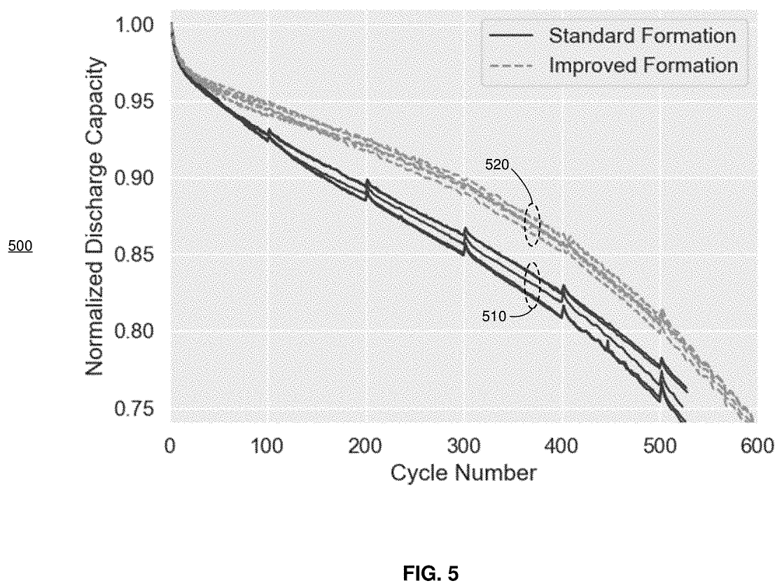

FIG. 5 is a graph diagram illustrating comparison in cycling performance of batteries between standard formation protocol and an improved formation protocol in accordance with the present disclosure. Shown in FIG. 5 is graph 500.

The graph 500 illustrates results of example operation runs using the same example Si/Li cell (battery) cell, with graph 500 specifically capturing normalized discharge capacity of the cell as a function of number of cycles during each of these runs.

In particular, as shown in FIG. 5, graph 500 includes line graphs 510 and 520, corresponding to, respectively, use of a standard formation protocol (line graphs 510) and use of an example improved formation protocol in accordance with the present disclosure (line graphs 520). In this regard, the standard formation protocol may include a charge at 1 C to 4.2 V until 0.05 C, discharge at 1 C to 2 V until 0.2 C for cycle 1, followed by charge at 1 C to 3.3 V until 0.05 C, rest 10 minutes for cycle 2.

The improved formation protocol may include charge at 1 C to 4.2 V until 0.05 C, discharge at 1 C to 2 V until 0.2 C for cycle 1, followed by charge at 1 C to 3.3 V until 0.05 C, rest 10 minutes for cycle 2, then followed by a high-temperature deep discharge cycle (cycle 3) that is performed throughout at a pre-set high temperature (e.g., at 45° C.), with the cycle including resting for 1 minute, charge at 0.1 C to 4.2 V until 0.02 C, rest 5 minutes, discharge at 0.1 C to 1 V until 0.02 C, rest 5 minutes.

As illustrated in line graphs 510 and 520, use of the improved formation protocol results in improved cycle performance—e.g., with cycle(s) with the improved formation protocol having improved retention after a number of cycles. In addition, the reversibility of formation (the initial coulombic efficiency) was improved—e.g., an increase in DCC/CC from 87% to 95%.

An example method of configuring battery performance, in accordance with the present disclosure, comprises providing a cell comprising a cathode, a separator, and a silicon-dominant anode, and applying to the cell one or more deep discharge cycles, with each of the one or more deep discharge cycles comprises at least charging and discharging the cell, and where each of the one or more deep discharge cycles is performed at a higher temperature that is above normal operating temperature range.

In an example embodiment, the silicon-dominant anode comprises silicon that is >50% of active material of the anode.

In an example embodiment, the method further comprises applying at least one of the one or more deep discharge cycles during formation of the cell.

In an example embodiment, the higher temperature is 40° C. or higher, 45° C. or higher, or around 45° C.

In an example embodiment, each of the one or more deep discharge cycles comprises using a discharge cutoff voltage that is below a normal operating voltage range of the cell.

In an example embodiment, each of the one or more deep discharge cycles comprises using a discharge cutoff voltage is 2.5V or less, 2V or less, or 1.5V or less.

In an example embodiment, the method further comprises using, during at least one deep discharge cycle, using at one or both of: a first charge rate that is different from a second charge rate used during normal operations of the cell, and a first discharge rate that is different from a second discharge rate used during normal operations of the cell.

In an example embodiment, the method further comprises using a constant voltage hold during at least part of a discharge step of at least one of the one or more deep discharge cycles, wherein the voltage hold is at a voltage below a normal operating voltage of the cell.

In an example embodiment, the voltage hold is at or around 2.5V, at or around 2.0V, or at or around 1.5V.

In an example embodiment, the method further comprises using, in conjunction with the voltage hold, a cutoff current at or around 0.1 C, at or around 0.05 C, or at or around 0.02 C.

In an example embodiment, the method further comprises charging and discharging the cell through a plurality of cycles or through regular use that is equivalent to a plurality of cycles in between the one or more deep discharge cycles.

In an example embodiment, the method further comprises performing the one or more deep discharge cycles at regular intervals.

In an example embodiment, the method further comprises performing at least some of the one or more deep discharge cycles at random intervals.

In an example embodiment, the method further comprises configuring the deep discharge cycle using a battery management system.

In an example embodiment, the battery management system is integrated with the cell.

In an example embodiment, the battery management system is external to the cell.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method of configuring battery performance, the method comprising:
providing a cell comprising a cathode, a separator, and a silicon-dominant anode;
applying to the cell one or more deep discharge cycles, wherein each of the one or more deep discharge cycles comprises at least charging and discharging the cell; and
in at least one deep discharge cycle of the one or more deep discharge cycles, performing one or both of charging and discharging of the cell at a higher temperature that is above a normal operating temperature range applicable to a same one of charging and/or discharging of the cell during normal operations of the cell.

2. The method of claim 1, wherein silicon-dominant anode comprises silicon that is >50% of active material of the anode.

3. The method of claim 1, further comprising applying at least one of the one or more deep discharge cycles during formation of the cell.

4. The method of claim 1, wherein the higher temperature is 40° C. or higher, 45° C. or higher, or around 45° C.

5. The method of claim 1, wherein each of the one or more deep discharge cycles comprises using a discharge cutoff voltage that is below a normal operating voltage range of the cell.

6. The method of claim 5, wherein each of the one or more deep discharge cycles comprises using a discharge cutoff voltage is 2.5V or less, 2V or less, or 1.5V or less.

7. The method of claim 1, further comprising using, during at least one deep discharge cycle, one or both of: a first charge rate that is different from a second charge rate used during normal operations of the cell, and a first discharge rate that is different from a second discharge rate used during normal operations of the cell.

8. The method of claim 1, further comprising using a constant voltage hold during at least part of a discharge step of at least one of the one or more deep discharge cycles, wherein the voltage hold is at a voltage below a normal operating voltage of the cell.

9. The method of claim 8, wherein the voltage hold is at or around 2.5V, at or around 2.0V, or at or around 1.5V.

10. The method of claim 8, further comprising using, in conjunction with the voltage hold, a cutoff current at or around 0.1 C, at or around 0.05 C, or at or around 0.02 C.

11. The method of claim 1, further comprising charging and discharging the cell through a plurality of cycles or through regular use that is equivalent to a plurality of cycles in between the one or more deep discharge cycles.

12. The method of claim 1, comprising performing the one or more deep discharge cycles at regular intervals.

13. The method of claim 1, comprising performing at least some of the one or more deep discharge cycles at random intervals.

14. The method of claim 1, comprising configuring the deep discharge cycle using a battery management system.

15. The method of claim 14, wherein the battery management system is integrated with the cell.

16. The method of claim 14, wherein the battery management system is external to the cell.
